(19) United States
(12) Patent Application Publication
(10) Pub. No.: US 2018/0127085 A1
(43) Pub. Date: May 10, 2018

(54) Propeller

(71) Applicant: Troy Churchill, Escondido, CA (US)

(72) Inventor: Troy Churchill, Escondido, CA (US)

(21) Appl. No.: 15/805,862

(22) Filed: Nov. 7, 2017

Related U.S. Application Data
(60) Provisional application No. 62/418,603, filed on Nov. 7, 2016.

(51) Int. Cl. B64C 11/18; F04D 29/38

(52) U.S. Cl. CPC B64C 11/18; F04D 29/384

(57) ABSTRACT

This invention is directed toward a propeller with one of more propeller blades. The propeller blades have some combination of a sharpened leading edge, one or more steps on the upper or lower surface of the propeller blade, and an “S” shape. The combination of these radical changes from traditional propeller design creates a quieter, more efficient propeller that has applications on any device that uses propellers: from quadcopters and airplanes to boats and fans. Propellers with one, two, three, four, five and more propeller blades are contemplated depending upon the substance the propeller is intended for use in.

### CROSS REFERENCE TO RELATED APPLICATIONS

This application claims priority from U.S. Provisional No. 62/418,603 which was filed Nov. 7, 2016, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

Field of the invention: This invention relates to a propeller with one or more propeller blades which have some combination of a sharpened leading edge, one or more steps on either/and the top surface and/or bottom surface, and an “S” shaped blade.

History of the invention's industry. Propellers have been used for centuries, providing propulsion for airplanes and boats, air movement for cooling houses and industrial spaces, with even micro-fans cooling off computer circuit boards. Over the years, it is almost as though there have been a number of “urban legends” that have developed over what will and will not work with propellers. This invention takes three of these myths and provides a revolutionary new propeller design that disproves all three.

For example, conventional wisdom holds that the leading edge of a propeller or wing has to be rounded. The current invention uses a sharp leading edge and produces superior results. Propellers of the past also had a slightly curved, but smooth upper surface. The current invention provides a propeller blade with one, at a minimum, step on the upper surface of the propeller blade. This results in a more efficient, and quieter propeller. A third disruptive technology advanced by this patent is an “S” shaped propeller blade. Propeller blades in the past may have had slight bends to them, but nothing like the clear “doubling back on itself twice” that this invention claims.

The invention contemplates a number of variations on this theme, which will be illustrated in the specification and drawings below. Included are steps—both steps “up” and “down” on the upper and lower surfaces of the propeller, “S” bends of various degrees, steps of various heights, different numbers of steps and steps in different location, and leading edges with different degrees of sharpness.

### OBJECTS OF THE INVENTION

It is therefore an object of the present invention to provide a propeller that is quieter and more efficient than traditional propellers.

Other objects include providing a sharp leading edge, providing a step in the surface of the propeller, and providing an “S” shape to the propeller.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a side, perspective view of a propeller according to a preferred form of the invention.

FIG. 2 is a top view of the invention.

FIG. 3 is a bottom view of the invention.

FIG. 4 is a side view of the invention.

FIG. 5 is a cross-sectional view of the invention.

FIG. 6 is a top view of a three-bladed version of the invention.

FIG. 7 is a series of cross-sectional views showing the step at various distances from the hub of the propeller.

As a general summary of the invention, there are three inventive steps combined in this invention. First, there is at least one step in the top surface and/or bottom surface of the propeller. Second, the leading edge of the propeller is sharp, rather than the blunt or rounded leading edge of traditional propellers. Third, the propeller blade is not linear, but rather “S” shaped.

These three innovations combine to create a propeller that inherently reduces noise and increases efficiency. The propeller is suitable for use in all aeronautical propulsion and lifting applications such as aircraft, helicopters, drones, jets, and any vehicle or craft benefiting from a more efficient and quieter propulsion system. The propeller can also be used for boats, fans, and any other device which moves gas or liquid.

The specific design is a propeller/prop or fan blade that incorporates unique characteristics into its design to achieve a substantially reduced drag coefficient over the propeller's upper and/or, lower surface area and in turn, increases propulsion efficiency and reduces noise decibel levels. The improved design can reduce fuel and energy consumption and additional decrease sound disturbances. Features include 1) a step, ridge and/or, hard depression into the upper and/or, lower surface of the propeller. 2) a sharpened leading edge (LE) and 3) an organic “S” shape blade design which can be rounded or pointed or a combination of both. Together these features make a more efficient propulsion system for use in all aeronautical, marine and transportation systems requiring a more efficient and quieter propulsion system over that which is currently available. This design is uniquely suited for use in surveillance and military drone applications where extended range and silent operations are key components to vehicle design criteria.

This propeller/prop or fan blade design, would be used in aerospace applications (commercially, privately and militarily). The design lends itself to use in any application which could benefit from a propeller or fan blade which reduces sound levels and can produce improved thrust efficiency and lower energy consumption over conventional designs.

Physical candidates for the propeller are, prop driven air craft, commercial turbine engines, military aircraft, turbine engines, commercial jets, private jets, private propeller driven aircraft, helicopter rotor blades, surveillance drones, multi-rotor drones, etc.

The propeller design is made in much the same manner as any traditional propeller/prop or fan blade would be made and can be manufactured from Plastic (all forms), Aluminum, Sheet metal, Titanium, Alloys, Steel, Wood (laminated and solid), Composites (all forms including carbon, fiberglass, Kevlar, S-glass, E-glass and all hybrid forms of fiberglass including woven thermal plastics and honeycomb constructions), Marble, Stone and even Glass. This design is suitable for all materials commonly used to manufacture propeller/props and fan blades.

This propeller design can be made in all traditional blade configurations ranging from a single blade design, 2 blades, 3 blades, 4 blades, 5 blades and all the way to turbine engines using many blades. The application lends itself to improve any currently available propeller/prop or fan blade design.

The uniqueness in design of this propeller/prop or fan blade brings three major characteristic improvements into a single propeller/prop or fan blade design to decrease its energy efficiency and reduce overall noise levels current designs and products. A quieter propulsion drive system in defense applications reduces vehicle recognition, increases the secrecy of surveillance vehicles and reduces fuel costs due to improvements in airflow efficiencies of the surfaces of the propeller. The envelope of uses for this propeller design is enormous in scope.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### REFERENCE NUMBERS USED

1. Propeller generally
2. Leading edge
3. Step
4. Trailing edge
5. Direction of rotation
6. Airflow over upper surface
7. Airflow over lower surface
8. Vortex
9. Sharp Leading edge
10. S-shaped curve
11. Angle

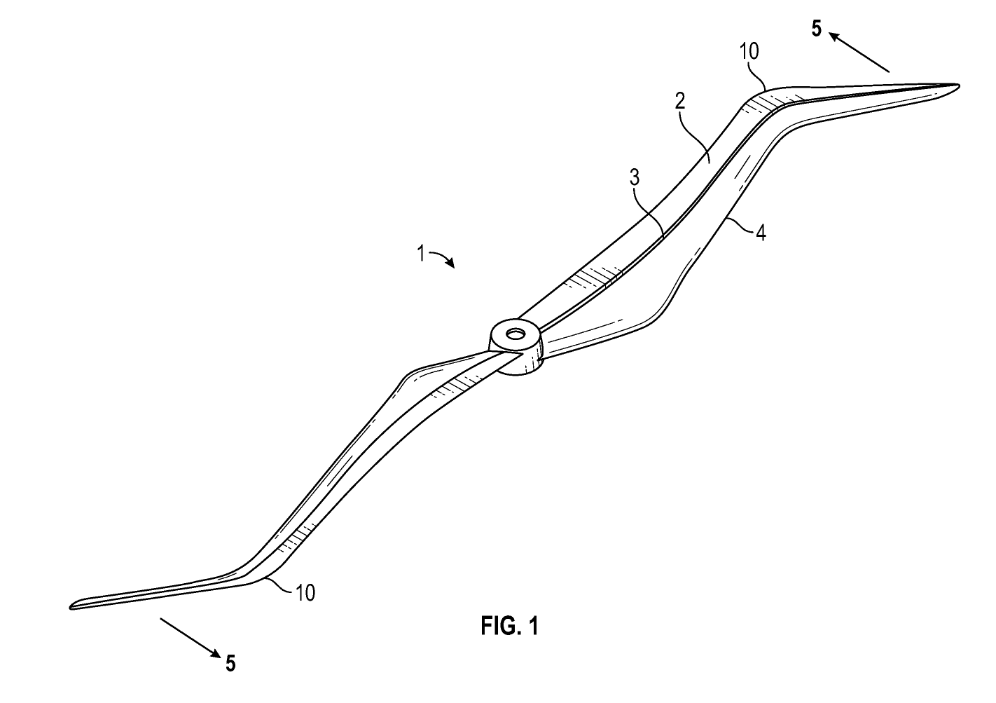

FIG. 1 is a side, perspective view of a propeller according to a preferred form of the invention. This version is a 2-bladed propeller, generally referenced as 1, which has an S-shaped curve 10, and rotates in direction 5. The S-shaped curve, 10, makes the propeller 1 quieter and more efficient. The propeller has a leading edge 2, which is the side of the propeller blade that first cuts through the air. In this invention, the leading edge 2 is sharp, which is in direct contrast to the general school of thought on propellers and wings, which is that a sharp leading edge will create instability. However, with the step 3 on the top of the propeller 1, a sharp leading edge 2 actually contributes to a quiet and efficient movement through the air. The propeller 1 has a trailing edge 4, which also has the characteristic “S-shaped” bend to it.

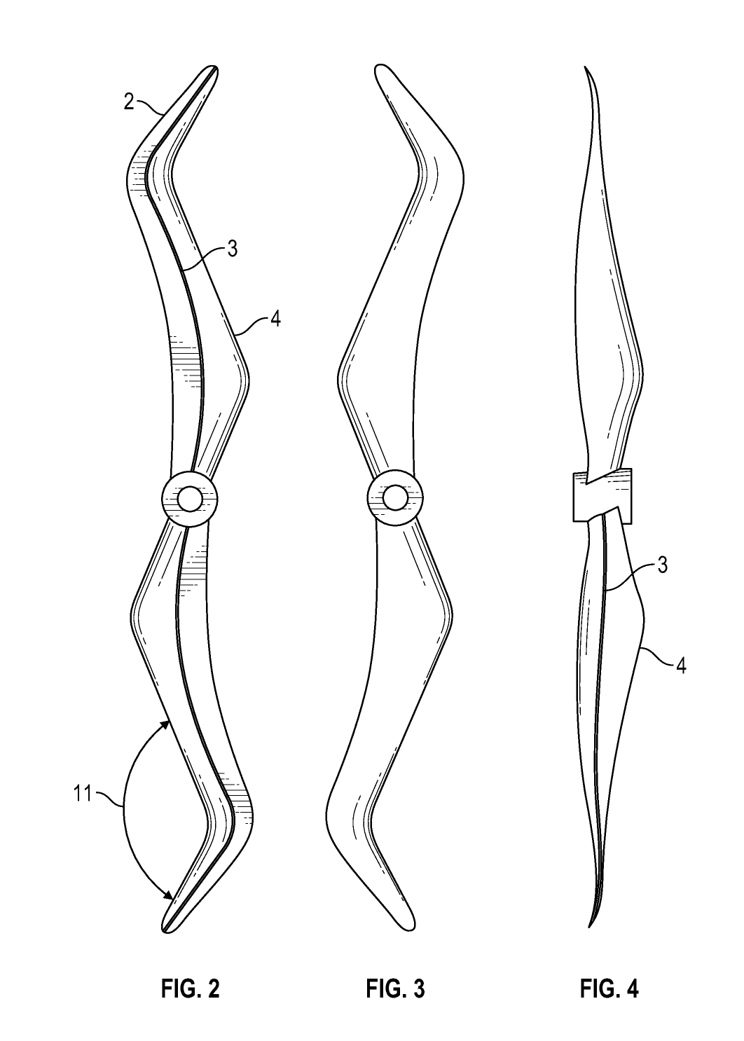

FIG. 2 is a top view of the invention. This figure shows clearly the leading edge 2, the location of the step 3, and the trailing edge 4. The S-shaped curve 10 has an angle 11, with reflect the “bend” in the propeller. A number of different angles are preferred depending on the shape of the propeller and the purpose for which it may be used (racing, lifting, endurance), but a preferred embodiment calls for the angle to be greater than 90 degrees.

FIG. 3 is a bottom view of the invention. It should be noted that the bottom of the propeller does not have a step in it in this embodiment of the invention, but other contemplated embodiments do have a step in the bottom.

FIG. 4 is a side view of the invention.

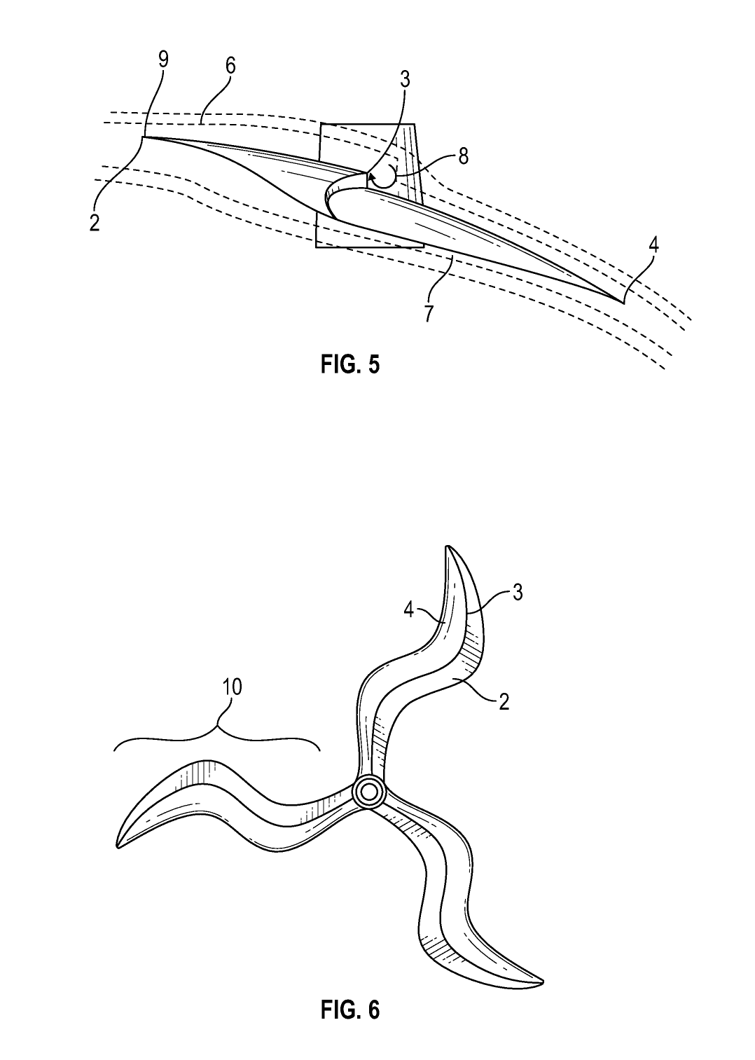

FIG. 5 is a cross-sectional view of the invention showing the function of the step 3. As air rushes over the upper surface 6 of the wing, a vortex 8 is created directly behind the step 3. This vortex 8 then causes the airflow over upper surface 6 to be pulled down over the trailing edge 4 of the propeller, increasing the efficiency, decreasing noise, and increasing thrust. This figure also illustrates the sharp leading edge 9, which is a significant contradiction to the traditionally blunted leading edge.

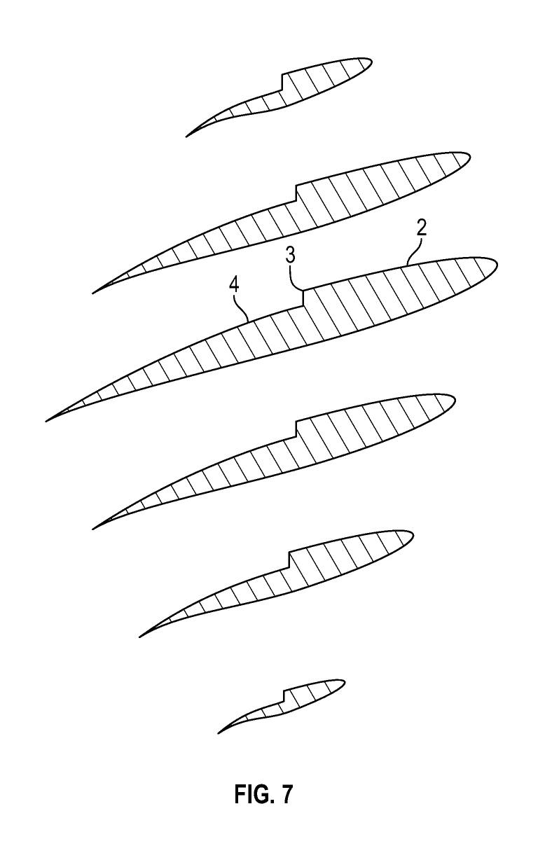

FIG. 6 is a top view of a three-bladed version of the invention.

FIG. 7 is a series of cross-sectional views showing the step at various distances from the hub of the propeller.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. For example, 3-, 4-, 5- and 6-bladed propellers are contemplated, and the use of this technology for air and water is contemplated.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A propeller, where the propeller has two propeller blades, where each propeller blade has an “S” shape curve, where the “S” shape curve has an angle, and where the angle is greater than 90 degrees, where each propeller blade consists of a leading edge, where the leading edge is a sharp leading edge, a trailing edge, a top surface and a bottom surface, and a propeller depth, where the top surface has a step, where the step comprises a rapid decrease in the propeller depth from the leading edge to the trailing edge, where the propeller has an efficiency, and an amount of noise that is generated by a rotation of the propeller.

2. The propeller blade of claim 1, where when air flows over the top surface of the propeller blade, a vortex is created behind the step, and where the vortex forces a quantity of air in a downward direction at the trailing edge of the propeller blade, thereby increasing the efficiency of the propeller.

3. The propeller blade of claim 2, where the vortex forces a quantity of air in a downward direction at the trailing edge of the propeller blade, thereby decreasing the amount of noise from the rotation of the propeller.

4. A propeller, where the propeller has two or more propeller blades, where each propeller blade has an “S” shape curve, where each propeller blade comprises a leading edge, a trailing edge, a top surface and a bottom surface, and a propeller depth.

5. The propeller of claim 4, where the leading edge is a sharp leading edge

6. The propeller of claim 5, where the top surface has a step, where the step comprises a rapid decrease in the propeller depth from the leading edge to the trailing edge, where the propeller has an efficiency, and an amount of noise that is generated by a rotation of the propeller.

7. The propeller of claim 6, where when air flows over the top surface of the propeller blade, a vortex is created behind the step, and where the vortex forces a quantity of air in a downward direction at the trailing edge of the propeller blade, thereby increasing the efficiency of the propeller.

8. The propeller blade of claim 7, where the vortex forces a quantity of air in a downward direction at the trailing edge of the propeller blade, thereby decreasing the amount of noise from the rotation of the propeller.

9. The propeller of claim 4, where the top surface has a step, where the step comprises a rapid decrease in the propeller depth from the leading edge to the trailing edge, where the propeller has an efficiency, and an amount of noise that is generated by a rotation of the propeller.

10. The propeller of claim 9, where the leading edge is a sharp leading edge

11. The propeller of claim 10, where when air flows over the top surface of the propeller blade, a vortex is created behind the step, and where the vortex forces a quantity of air in a downward direction at the trailing edge of the propeller blade, thereby increasing the efficiency of the propeller.

12. The propeller blade of claim 11, where the vortex forces a quantity of air in a downward direction at the trailing edge of the propeller blade, thereby decreasing the amount of noise from the rotation of the propeller, and where the angle is greater than 110 degrees.

13. A propeller blade comprising: a leading edge, a trailing edge, a top surface and a bottom surface, where, the at least one of the top surface and the bottom surface has at least one step in it.

14. The propeller blade of claim 13, where the propeller blade has an “S” shape curve, where each propeller blade comprises a leading edge, a trailing edge, a top surface and a bottom surface, and a propeller depth.

15. The propeller of claim 14, where the leading edge is a sharp leading edge and where the angle is greater than 90 degrees.

16. The propeller of claim 15, when air flows over the at least one step of the propeller blade, a vortex is created behind the step, and where the vortex forces a quantity of air in a downward direction at the trailing edge of the propeller blade, thereby increasing the efficiency of the propeller.

17. The propeller blade of claim 16, where the vortex forces a quantity of air in a downward direction at the trailing edge of the propeller blade, thereby decreasing the amount of noise from the rotation of the propeller.

18. The propeller blade of claim 17, where the at least one step is located on the top surface of the propeller blade, and the step is a downward step.

19. The propeller blade of claim 17, where the at least one step is located on the bottom surface of the propeller blade.

20. The propeller blade of claim 17, where there are two steps, and one step is located on the top surface of the propeller blade, and one step is located on the bottom surface of the propeller blade.
